(19) United States
(12) Patent Application Publication
(10) Pub. No.: US 2009/0095137 A1
(43) Pub. Date: Apr. 16, 2009

(54) Specialized Socket for Installing Valve

(76) Inventor: Randy McKee, Prague, OK (US)

Correspondence Address: CARSTENS & CAHOON, LLP, P O BOX 802334, DALLAS, TX, 75380, US

(21) Appl. No.: 12/249,539

(22) Filed: Oct. 10, 2008

Related U.S. Application Data
(60) Provisional application No. 60/978,973, filed on Oct. 10, 2007.

(51) Int. Cl. B25B 13/06

(52) U.S. Cl. 81/121.1

(57) ABSTRACT

A removable valve socket wrench for installing and removing pipe valves. The socket may be attached to an end of a ratchet, torque wrench, T-bar, or breaker bar with an extendable wrench handle. A detent feature is provided to allow the socket to positively engage the handle and be physically retained yet removable. The socket features various openings in the socket walls to engage with protruding features of a particular valve.

### CROSS-REFERENCE TO RELATED APPLICATIONS

This application claims the benefit of provisional Application No. 60/978,973, filed Oct. 10, 2007.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

This invention relates to plumbing tools, and more particularly, to a socket head for a wrench that may be used in conjunction to install and operate below-ground pipe valves.

2. Description of Related Art Including Information Disclosed Under 37 CFR 1.97 and 1.98

Underground and other hard to reach valves are typically installed and serviced using one of several existing styles of T-bar or torque wrench having a sufficiently long shaft to reach such valves. Some of these wrenches have replaceable socket heads attached to the distal end of such wrench. Several patents disclose various inventions related to such plumbing tools.

U.S. Pat. No. 5,316,040 issued on May 31, 1994, to Townsend et al. describes a valve alignment tool for correctly aligning a valve box above each shutoff valve in water pipes of an underground water main. The tool fits over the square stem nut of a gate valve. The top of the tool contains a bubble level. When the trench around the water main is filled, the valve alignment tool is removed. The tool has a non-folding handle and a non-telescopic shaft. This device is distinguishable because it has a non-changeable socket head portion.

U.S. Pat. No. 394,733 issued on Dec. 18, 1888, to Staats et al. describes a curb-stop device comprising a capped stop box encasing a valve and having a flanged base. The box base has ways which cooperate with shoulders in the pipeline to maintain stability. The invention has a long shaft with an offset handle on top and a fixed socket wrench head at the distal end. This invention is distinguishable for its one-piece construction.

U.S. Pat. No. 5,138,911 issued on Aug. 18, 1992, to Lan describes a telescopic wrench extension device comprising a tubular member having a closed end portion with a longitudinal slot with multiple enlarged apertures and a polygonal axial recess for accessing a socket wrench; and, a shaft member having a first end slidably extending into the tubular member and a second end extending out of the tubular member and having an axial socket operating portion that is polygonal in cross-section to engage a wrench socket. The shaft member has a means to keep it fixed at a constant position relative to the tubular member. This device is distinguishable for its slotted construction of the telescopic shaft.

U.S. Pat. No. 4,817,663, issued to McAndrew on Apr. 4, 1989, for a hall or plug valve stem extension and lock mechanism, discloses a fluid control valve stem extension comprising a rod member to extend the valve stem. The end of the rod member supports a torque wheel to turn the rod and, hence, open or close the fluid valve. This invention is distinguishable by noting that the rod is permanently attached to the valve stem by means of a set screw.

U.S. Pat. No. 3,691,877 issued on Sep. 19, 1972, to Joseph W. Harris describes a wrench having a pair of long handles with upper receiving apertures for pins attached to the inside opposing portions of horizontal crossbars. The working ends of the handles are bifurcated and attached to a wrench with open jaws. The tool is operated by holding one handle stationary and moving the other handle. This tool is distinguishable for its two handle construction and fixed wrench head.

U.S. Pat. No. 1,759,221 issued on May 30, 1930, to Carson describes a mine gas shutoff valve structure employing a spring holding the large end of a tapered plug. A singular structured socket wrench with a long shaft and a perpendicular handle is disclosed. This socket wrench is distinguishable for its one-piece construction.

U.S. Pat. No. 1,321,776 issued on Nov. 11, 1919, to Stepanian describes a one-piece wrench for adjusting grease cups and petcocks having an elongated T-shaped handle and a flaring head member with V-shaped slots forming four finger elements with internal serrated teeth at three different levels or diameters. This invention is distinguishable for its slotted and serrated teeth structure of the flaring head member, and for its one-piece construction.

U.S. Pat. No. 169,489 issued on Nov. 2, 1875, to Smeaton describes an improvement in a multi-storied rod handle for a water stopcock wrench head which has two prongs which contact the stopcock but not the plug handle. This wrench is distinguishable for its lengthy non-telescopic handle specially designed for multi-storied buildings.

None of these prior-art inventions fills the need for an economical and versatile plumbing tool with interchangeable heads which can be used to install and operate valves especially where valves are difficult to reach with conventional tools. Accordingly, a need exists for an economical plumbing tool having interchangeable heads which can be removably fixed to the distal end of a wrench handle. Further, a need exists for a set of wrench heads having features which are contoured to, and couple snuggly onto, the matching features of a valve. None of the above prior-art inventions and patents, taken either singly or in combination, is seen to describe the instant invention as claimed.

These and other improvements will become apparent when the following detailed disclosure is read in light of the supplied drawings. This summary is not intended to limit the scope of the invention to any particular described embodiment or feature. It is merely intended to briefly describe some of the key features to allow a reader to quickly ascertain the subject matter of this disclosure. The scope of the invention is defined solely by the claims when read in light of the detailed disclosure.

### BRIEF SUMMARY OF THE INVENTION

A versatile tool for installing and operating valves for pipes is provided. Socket heads may be removably attached to one end of an extendable handle of the tool. Various heads have features which facilitate coupling of each head to a particular valve. Such socket heads serve a variety of purposes involving the installation and operation of valves.

### BRIEF DESCRIPTION OF THE SEVERAL VIEWS OF THE DRAWING(S)

The present invention will be more fully understood by reference to the following detailed description of the preferred embodiments of the present invention when read in conjunction with the accompanying drawings, wherein:

FIG. 1 is top perspective view of a removable valve wrench socket head according to one embodiment of the present invention;

FIG. 2 is bottom perspective view of a removable valve wrench socket head having its grooves aligned with the corresponding features of a valve according to one embodiment of the present invention;

FIG. 3 is perspective view of a house, a pipe leading from the house, and a main pipe to which is installed a valve with a removable valve wrench socket head according to one embodiment of the present invention;

FIG. 4 is a back view of one embodiment of the present invention showing the square sides of a sturdy outer body, a hexagonal connecting member, slots for valve features (partially in dashed lines), and a pin hole as a connecting feature of the removable socket head;

FIG. 5 is an overhead view of one embodiment of the present invention showing the square sides of a sturdy outer body, a hexagonal connecting member, slots for valve features in dashed lines, and a pin hole in dashed lines as a connecting feature of the removable socket head;

FIG. 6 is a front view of one embodiment of the present invention showing the square sides of a sturdy outer body, a hexagonal connecting member, slots for valve features (partially in clashed lines), and a pin hole in dashed lines as a connecting feature of the removable socket head; and,

FIG. 7 is a right side view of one embodiment of the present invention showing the square sides of a sturdy outer body, a hexagonal connecting member, slots for valve features (partially in dashed lines), and a pin hole in dashed lines as a connecting feature of the removable socket head.

The above figures are provided for the purpose of illustration and description only, and are not intended to define the limits of the disclosed invention. Use of the same reference number in multiple figures is intended to designate the same or similar parts. Furthermore, when the terms “top,” “bottom,” “first,” “second,” “upper,” “lower,” “height,” “width,” “length,” “end,” “side,” “horizontal,” “vertical,” and similar terms are used herein, it should be understood that these terms have reference only to the structure shown in the drawing and are utilized only to facilitate describing the particular embodiment. The extension of the figures with respect to number, position, relationship, and dimensions of the parts to form the preferred embodiment will be explained or will be within the skill of the art after the following teachings of the present invention have been read and understood. (58,266).

### DETAILED DESCRIPTION OF THE INVENTION

While the present invention is described below with respect to a preferred embodiment and with reference to the attached figures, other embodiments are possible. The concepts disclosed herein apply equally to other removable socket heads for installing and operating plumbing valves.

The present invention utilizes a universal torque rod or ratchet device handle to which one of a plurality of differently sized removable valve wrench socket heads may be individually attached to the distal end thereof. The socket wrench heads may each be color coded to indicate its specific size. A handle may be added to one end of a torque rod thus forming a T-bar configuration. Both the handle and shank of a T-bar are extendible. As used herein, the term “wrench handle” is used to indicate a ratchet wrench, torque bar, T-bar, breaker bar, or the like.

In the first embodiment, the shank comprises a hexagonally shaped limiting collar which may be impacted by a slide hammer that rides over the upper shank portion of an attached torque rod. The slide hammer is useful in engaging and fitting the socket end of the torque bar to rusted or earth encrusted valve stems. Such limiting collar also provides a receiving means for an operator to apply additional torque to the socket head with a wrench or other such tool.

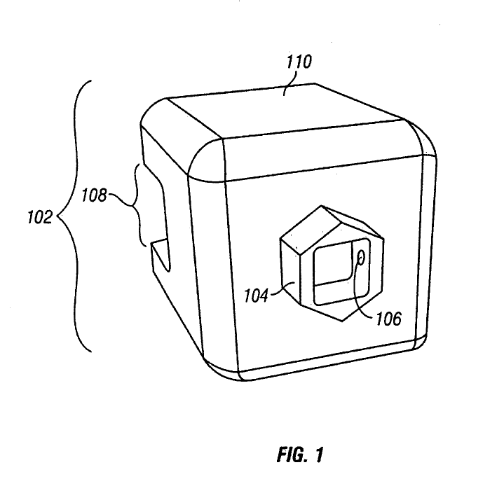

FIG. 1 illustrates a first embodiment of the present invention. As depicted, the removable valve wrench socket head (102) features an attachment collar (104) having a hexagonal outer surface, a square drive inner surface, and a socket retention pin hole (106). While a square drive inner surface is depicted, other types of ratchet drives are acceptable and are within the scope of the invention. For example, certain ratchet wrenches employ a spline drive to engage a ratchet to a socket.

The socket in the present embodiment is manufactured from steel with an oxide coating applied to prevent corrosion. However, chrome plating or plastic coating may also be utilized and are within the scope of the invention. The material chosen must be sufficiently rigid to prevent the socket walls from deforming under load, yet ductile enough to prevent the walls from cracking due to the stresses.

The pin hole (106) assists in retaining the socket head (102) on the wrench handle (not shown) during its operation. The wrench features a detent ball or pin or other such mechanism which engages the wrench head pin hole (106). There are also one or more slots or openings (108) formed in the sides or top of the socket head 102. A slot or opening (108) is formed to match the dimensions of one or more features of a removable valve (not shown).

A removable valve wrench socket head (102) also may have one or more sides having no openings (110). When the socket head (102) is placed over a valve, the socket head (102) may be operated to install, open or close a valve depending on the features of the particular socket head (102).

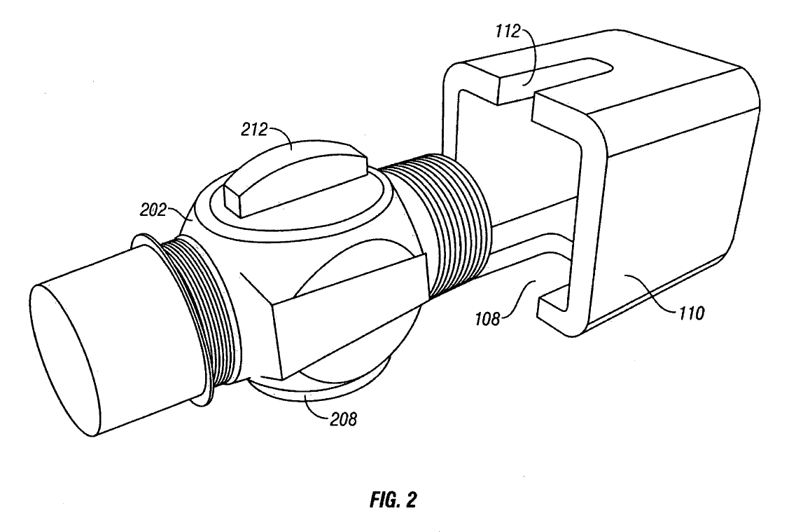

FIG. 2 shows one embodiment of a removable valve wrench socket head (102) selected to match, and aligned with, a removable valve (202). The socket features a narrow opening in one wall (112) that accepts the valve handle (212). A larger opening on the opposite socket wall (108) accepts the larger protrusion on the base of the valve (208). The socket is used by positioning it over the valve (202) such that the openings engage the valve's protrusions and rotating the socket with the ratchet or other connected handle. By engaging one or more valve features with its formed elements, the socket head is able to more effectively avoid wear and damage to a valve.

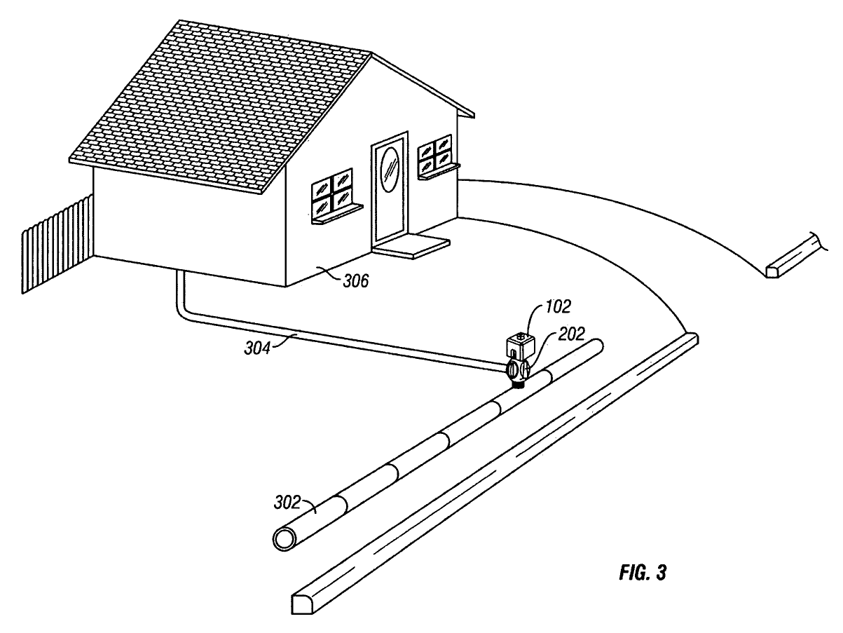

FIG. 3 illustrates one environment in which a removable valve wrench socket head (102) may be used: installing and removing valves as part of a water line from a residential water main. A removable valve wrench socket head (102) is used to install the valve (202) into a threaded hole inside a water main pipe (302) running near a residential house (306). The socket (102) may also be used to remove the valve (202). In this scenario, a connecting pipe (304) is fixed at one end inside the residence (306). At the other end, the correcting pipe (304) is attached to the newly assembled valve (202). The connection may be made by a worker who drills a one inch hole into a main water pipe (302), taps it to create one inch tapered threads in the hole, inserts a valve (202), and runs a copper line to meter box. Such connecting line between the meter box and water main is typically about 8 to 40 feet depending on the circumstances.

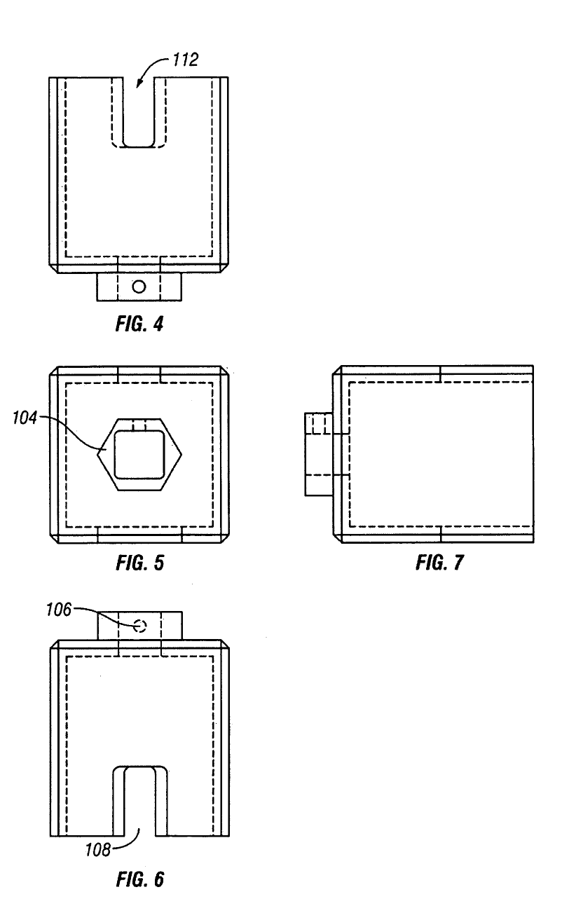

FIGS. 4-7 show several views of one embodiment of the socket (102) of the present invention. FIG. 4 depicts a back view of the socket (102) having square sides, a sturdy outer body, a hexagonal, collar (104), a narrow groove or slot (112) to mate with valve features, and a socket retention pin hole (106). FIG. 5 depicts an overhead view of such a socket (102) having a hexagonal connecting collar (104). FIG. 6 depicts a front view the socket (102) showing a larger slot or opening (108). FIG. 7 depicts a right side view of the socket (102) showing a solid side (110), and the hexagonal collar (104) with the pin hole (106).

The invention may be embodied in other specific forms without departing from the spirit or essential characteristics thereof. The present embodiments are therefore to be considered in all respects as illustrative and not restrictive. Accordingly, the scope of the invention is established by the appended claims rather than by the foregoing description. While various alterations and permutations of the invention are possible, the invention is to be limited only by the following claims and equivalents.

I claim:

1. A socket wrench for applying rotational pressure to a plumbing valve, the socket wrench comprising:
a collar for removeably engaging a wrench handle;
a rigid wall having an inner and outer surface, wherein at least a portion of the valve fits within the socket and contacts the inner surface; and
a first opening in the outer wall, wherein the opening is sized to engage at least one feature of the valve.

2. The socket wrench of claim 1 wherein the collar further comprises a hexagonal feature for engaging the jaws of a handheld wrench.

3. The socket wrench of claim 1 wherein the collar further comprises a pin hole.

4. The socket wrench of claim 1, the socket wrench further comprising:
a second opening, wherein the opening is sized to engage at least one feature of the valve.

5. The socket wrench of claim 4 wherein the first and second openings have different dimensions.

6. The socket wrench of claim 1 wherein the collar comprises a square drive feature.

7. The socket wrench of claim 1 wherein the collar comprises a spline drive feature.
